(19) United States
(12) Patent Application Publication
(10) Pub. No.: US 2022/0051339 A1
(43) Pub. Date: Feb. 17, 2022

(54) FINANCIAL INVESTMENT PRODUCT AND METHOD UTILIZING A REINSURANCE PLATFORM

(71) Applicants: Donald Andrews, Chicago, IL (US); David Chapman, Chicago, IL (US); Jodan Ledford, Chicago, IL (US)

(72) Inventors: Donald Andrews, Chicago, IL (US); David Chapman, Chicago, IL (US); Jodan Ledford, Chicago, IL (US)

(21) Appl. No.: 16/992,829

(22) Filed: Aug. 13, 2020

(51) Int. Cl. G06Q 40/08; G06Q 40/06

(52) U.S. Cl. CPC G06Q 40/08; G06Q 40/06

(57) ABSTRACT

The present invention creates a structure and system which reduces the expenses associated with selling, administering, and managing annuities. The present invention provides a well-managed set of TDFs that offer participants the opportunity, but not the obligation, to purchase an annuity at any time using all or a portion of a participant's plan account invested in the target date fund. This functionality permits participants to annuitize all or a portion of their account balance. The present invention further provides cheaper and easier access to annuity options than are otherwise available in the marketplace because no commissions will be paid to an insurance broker. The present invention provides to plan participants in longer-dated TDFs an investment opportunity in the reinsurer. The reinsurer investment of the present invention provides these TDFs, as well as the participants, to realize the potential benefit of longevity profits, which typically would inure to the insurance company providing the annuities. The invention provides a system for managing a financial investment product in a defined contribution plan in which a participant makes a contribution to the defined contribution plan on a regular periodic basis.

### FIELD OF THE INVENTION

The present invention relates to an investment product and method, more specifically a product utilizing an annuity purchase option and reinsurance arrangement.

### BACKGROUND OF THE INVENTION

There is a need to address issues with retirement plans that focus on retirement income by making access to annuities easier, more readily available and more economical. A Defined Contribution (DC) plan is a type of retirement plan in which an employer, employee or both make contributions on a regular basis. Individual accounts are established in a DC for participants and benefits are based on the amount credited to the accounts. The employee contributes a predetermined portion of his or her earnings into an account, all or part of the contribution may be matched by the employer. These contributions are invested in assets. Upon retirement, the participant's account may be used to provide retirement benefits, sometimes through the purchase of an annuity. In the United States, a 401(k) plan is a type of DC.

Defined contribution plans do not generally require, or even permit, a participant to receive his or her benefits in a stream of payments over his or her lifetime. As a result, a retired participant will bear the investment and longevity risks related to his or her defined contribution plan benefit during retirement. Most retirees do not have the resources or capabilities to successfully manage these risks. If a defined contribution plan does not offer an annuity option and a plan participant wants to purchase an annuity, the participant's only alternative currently is to take a distribution of the plan account and purchase an annuity from an insurer in the open market. The participant most likely will not have significant buying power in the marketplace because the participant's annuity purchase would be treated by insurers as a single, small transaction and does not allow for the ability to pool longevity risk as compared to an institutional investor which may be purchasing in bulk with not only a large amount of assets but also a larger number of lives in which longevity risk can be pooled. The participant may pay a commission to the insurance broker selling the annuity and the participant may receive annuity payments based on the participant's reduced buying power (after considering the broker fees). As a result, the purchase of the annuity potentially results in larger fees with a lower stream of payments to fund the participant's remaining lifetime cash flow needs.

Target Date Funds (TDF) (also known as LifeCycles, dynamic risk or age-based funds) are a collective investment scheme designed to provide a simple investment solution through a portfolio whose asset allocation mix becomes more conservative as the target date (usually retirement) approaches. Target date funds are commonly available as mutual funds.

There is a need for a product that provides participants in shorter-dated TDFs the opportunity to purchase fixed annuities based on a daily pricing quotation, while providing participants in longer-dated TDFs, the ability to receive longevity profits derived from the fixed annuities that are actually-issued.

The present invention supports the policy of providing lifetime income options available to participants in DC plans.

### SUMMARY OF THE INVENTION

The present invention creates a system that protects retirement plan participants while at the same time strengthening fiduciary standards. The present invention supports the recent efforts of the government to focus attention on retirement income by making access to annuities easier, more readily available and more economical.

The present invention creates a structure and system which reduces the expenses associated with selling, administering and managing annuities. The structure permits younger working participants to participate longevity profits which typically would be accrued only by insurance companies.

The present invention supports the government's policy of making lifetime income options available to participants in defined contribution plans. The present invention provides a superior option to a purchase of annuities in the general marketplace as a result of the following attributes.

The present invention provides a well-managed set of TDFs that offer participants the opportunity, but not the obligation, to purchase an annuity at any time using all or a portion of a participant's plan account invested in the target date fund. This functionality permits participants to annuitize all or a portion of their account balance.

The present invention provides cheaper and easier access to annuity options than are otherwise available in the marketplace because no commissions will be paid to an insurance broker. Moreover, because annuities will be available to a large group of plan participants, there should be significant buying power through the proposed structure when purchasing individual annuities which should, in turn, result in larger annuity payments to participants than otherwise available in the general marketplace.

By utilizing the structure of the present invention, a participant will likely have the ability to transfer his or her plan account assets in-kind to purchase an annuity, which reduces transaction costs to the participant and the insurer and, therefore, should increase the potential annual payment amounts to the participant under the annuity.

The present invention provides to plan participants in longer-dated TDFs an investment opportunity in the reinsurer. The reinsurer investment of the present invention provides these TDFs, as well as the participants, to realize the potential benefit of longevity profits, which typically would inure to the insurance company providing the annuities.

Because one investment manager will manage the assets of the TDFs as well as the Funds Held Assets supporting the annuities, the investment manager will base its fee on a larger pool of assets than it otherwise would manage in the absence of the annuity option. As a result, it is anticipated that the investment manager fees to the TDFs could be lowered by up to 20% over what would be available within the TDFs absent an annuity option.

One of the objects of the present invention is to provide annuity options for fund participants at a reduced cost to the participants.

Another object of the present invention is to minimize counterparty risk through the ability to self-insure the annuity or reinsure the annuity.

A further object of the present invention is to create pricing over time option for the annuity.

Yet another object of the present invention is to retain longevity exposure of an annuity written as a diversifying return to fund participants.

An additional object of the present invention is to establish a wholesale annuity provider model to provide annuity options for fund participants.

These and other objects and advantages of the present invention, as well as the details of the illustrative embodiments, will be more fully understood from the following figures and detailed description.

### BRIEF DESCRIPTION OF THE DRAWINGS

The financial investment product and method utilizing a reinsurance platform may be better understood with reference to the following drawings. The drawings are illustrative and are in no way limiting or exhaustive of the description of the present invention. Certain embodiments are disclosed with reference to the following drawings:

FIG. 1 is a diagram of the financial investment product of the present invention retirement fund;

FIG. 2 is a diagram of an embodiment of the financial investment product of the present invention retirement fund;

FIG. 3 is a diagram of another embodiment of the financial investment product of the present invention retirement fund;

FIG. 4 is a diagram of yet another embodiment of the financial investment product of the present invention retirement fund;

FIG. 5 is a descriptive flow chart of the financial investment product depicting the various components of the overall structure of the retirement product;

FIG. 6 is a flow chart of the financial investment product depicting the various fees;

FIG. 7 is a chart depicting the estimated costs of an annuity fee under the financial product of the present invention;

FIG. 8 is a chart demonstrating the estimated (not actual) impact on longer dated funds with reinsurance fund exposure; and

FIG. 9 is comparative charts showing the estimated (not actual) benefits of the proposed reinsurance retirement product.

### DETAILED DESCRIPTION OF THE PREFERRED EMBODIMENTS

In the following detailed description, numerous specific details are set forth in order to provide a thorough understanding of those embodiments. However, it will be understood by those of ordinary skill in the art that the invention is not limited to the preferred embodiment and that the invention may be practiced without the specific details of the embodiments set forth herein.

From the perspective of a DC plan participant, investing plan contributions in the structure or purchasing an annuity would be made more efficient than any currently available processes. In the present invention, money invested by a participant into the TDFs would be made through payroll deductions as may be done for most plans using a qualified default investment alternative. The qualified default investment alternative is intended to encourage investment of employee assets in appropriate vehicles for long-term retirement savings. However, participants in the plan of the present invention who are still saving for retirement may be able to adjust their contribution amounts or other plan investment options more effectively because the platform provides periodic annuity quotes to the investors such as daily, weekly or monthly quotes. The daily annuity quote will provide a basis to evaluate the performance of the annuity allowing a participant to choose current or projected retirement income.

Further, the annuity purchase process will be a significantly enhanced experience for participants. The structure enables participants to easily purchase an annuity within their plan (again, rather than sourcing it independently) and to transfer all or a portion of their plan account balance to the Insurer to cover the annuity cost rather than having to engage in a series of separate transactions.

The participant will be quoted an annuity with live pricing daily provided by a periodic annuity quote. Based on participant characteristics and/or preselected preferences, the participant may be quoted a single premium immediate annuity (SPIA), or a single premium deferred annuity (SPDA) with start date corresponding to anticipated retirement date.

Should the participant elect to purchase an annuity, the premium for the annuity would be paid from the participant plan account directly to the Insurer, and the premium may be paid in cash or via an in-kind transfer of assets from the investments held by the participant's plan account. The Insurer will deposit the premium, whether in cash or in kind, into the Funds Held Assets Account (the “Funds Held Assets”) maintained by the Insurer. It is expected that the insurance portfolio and a TDF approaching retirement (i.e., one designed for a participant near or in retirement) will likely have significant overlap in assets. Specifically, investments of the short-dated TDFs will focus on producing current income to participants, through and following retirement age, by investing in liquid, short-term, fixed income debt obligations, among other investments. Accordingly, for participants in the TDF approaching retirement (i.e., short-dated TDFs), an in-kind transfer of assets is expected to provide a significant cost savings because the transaction costs related to selling and buying the assets will be eliminated through the in-kind transfer.

The Funds Held Assets Account should be managed by an independent trustee and will have an independent Fund Accountant and Custodian arrangement outside of the Investment Manager. The Fund Held Assets will also have a clearly documented pricing policy to ensure pricing transparency. For in-kind asset transfers, the value of assets transferred in-kind from the Fund Held Assets will be determined by the independent Fund Accountant which will adhere to the documented pricing policy.

Once the premium (as cash and/or in-kind assets) is transferred, the annuity will be issued by the Insurer and held in the participant's plan account as a separate investment from other account holdings. The Investment Manager will be responsible for managing the Fund Held Assets. These assets will not be invested in any TDF or the Reinsurer Fund.

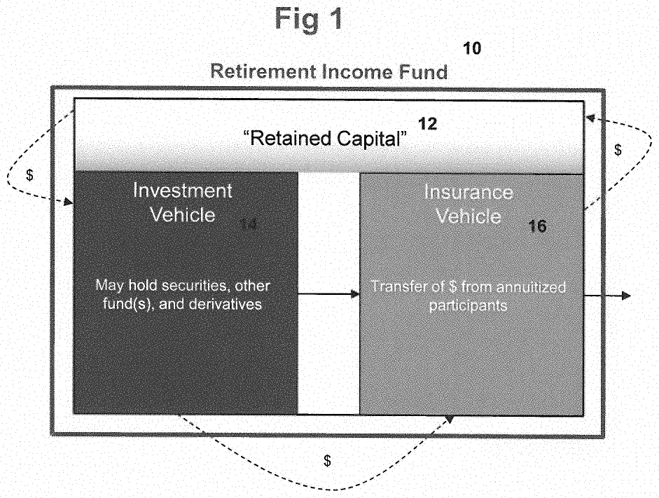

Turning to FIG. 1, the retirement investment fund 10 is a type of Target Date Fund. The investment fund 10 is described as having three components: (1) retained capital 12, (2) the investment vehicle 14 and (3) the insurance vehicle 16. The investment vehicle 14 may hold securities, other funds and derivatives. The insurance vehicle 16 comprises the funds transferred to the retirement income fund 12 from the group of annuity participants. Participants invest in the retirement income fund, and as appropriate, dividends are paid to the participants. The investments vehicle 14 may include a diversified growth fund as a way to spread risk and reduce the portfolio volatility. The investment vehicle 14 may function as a component of the targeted date retirement income fund 12. A participant in the retirement income fund 10 will accumulate units with additional contributions, and the balance will further increase as the fund assets increase. The participant may accumulate units in the retirement fund 10 and may elect to annuitize the assets based upon the accumulated units. The participants may enter into an annuity contract in the insurance vehicle 16. Any longevity returned from the insurance vehicle 16 is submitted to the retained capital 12 portion of the retirement income fund 10. The investment vehicle 14 bears the longevity risk of the insurance vehicle 16 if the retained capital 12 becomes insufficient or negative.

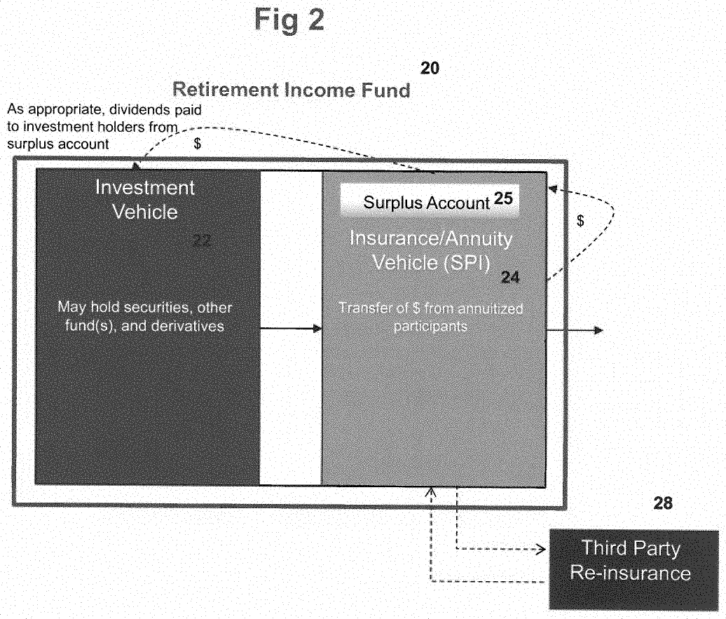

FIG. 2 is a variation of the retirement income fund 10 in which a mutual special purpose insurer is utilized. In FIG. 2, the investment vehicle 22 and an insurance/annuity vehicle 24. The investment fund 22 could include diversified growth funds, securities and/or derivatives. The investment fund 22 can function as a Target Date Fund solution. The participant in the retirement fund 20 may accumulate units in the fund 20 and elect to annuitize the investment by purchasing an insurance annuity vehicle 24. The insurance annuity vehicle 24 in the retirement income fund 20 is generated from the transfer of money from the annuitized participants. The longevity return or mortality credits flow into a surplus account 25. The participants of the annuity vehicle 24, enter into annuity contracts with the insurance vehicle. A third-party reinsurance plan 28 may be entered into an alleviate the exposure risk of the investment vehicle 22. The investment vehicle 22 may use assets, credits or other units to purchase the annuity vehicles 24. The money or dividends paid on the investment in the annuity vehicle by the annuitized participants may be returned to the investment fund 22.

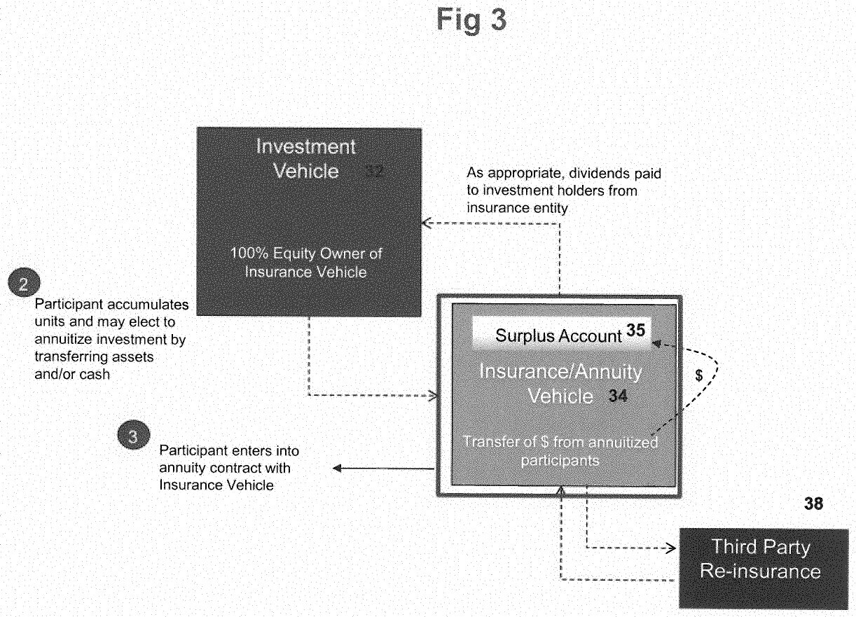

FIG. 3 depicts a retirement income special purpose insurer (SPI) 30 in which a wholly owned systematic investment plan is utilized. The SPI 30 includes three separate vehicles: (1) an investment vehicle 32, (2) an insurance/annuity vehicle 34 and (3) a third-party reinsurance platform 38. The investment vehicle 32 may hold securities, diversified growth funds or foreign investment funds or other types of derivatives. The investment vehicle 32 is wholly-owned by the participants of the plan. The participants may accumulate units from the investment vehicle 32 that they may elect to annuitize the units by either transferring assets to the annuity vehicle 34. The participants may enter into annuity contract supported by the annuity vehicle 34. The longevity return of participants flows into surplus account 35 in the annuity vehicle 34. A third-party reinsurance plan 38 may be utilized to reduce exposure of the annuity vehicle 34.

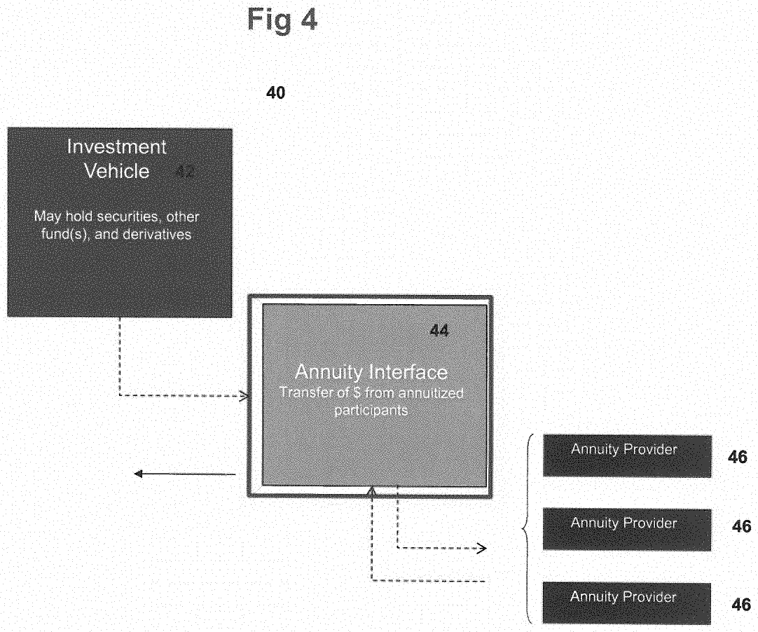

FIG. 4 describes an annuity wholesale platform 40 of the current invention. The annuity wholesaler platform 40 includes an investment vehicle 42, an annuity interface 44 and a plurality of annuity providers 46. The investment vehicle 42 could include securities, other funds or derivatives. In the annuity wholesale platform 42, the participant may accumulate units that he or she may elect to enter into an annuity investment by transferring assets and/or cash to an annuity interface 44. The annuity interface 44 operates to administer the various annuities. The annuity interface 44 further leverages the size of the product to get pricing for a periodic annuity quote. The participants may receive an annuity stream from the annuity interface 44. The annuity interface 44 further operates to coordinate with annuity providers to diversify the portfolio across counterparties to stay under guarantee limits.

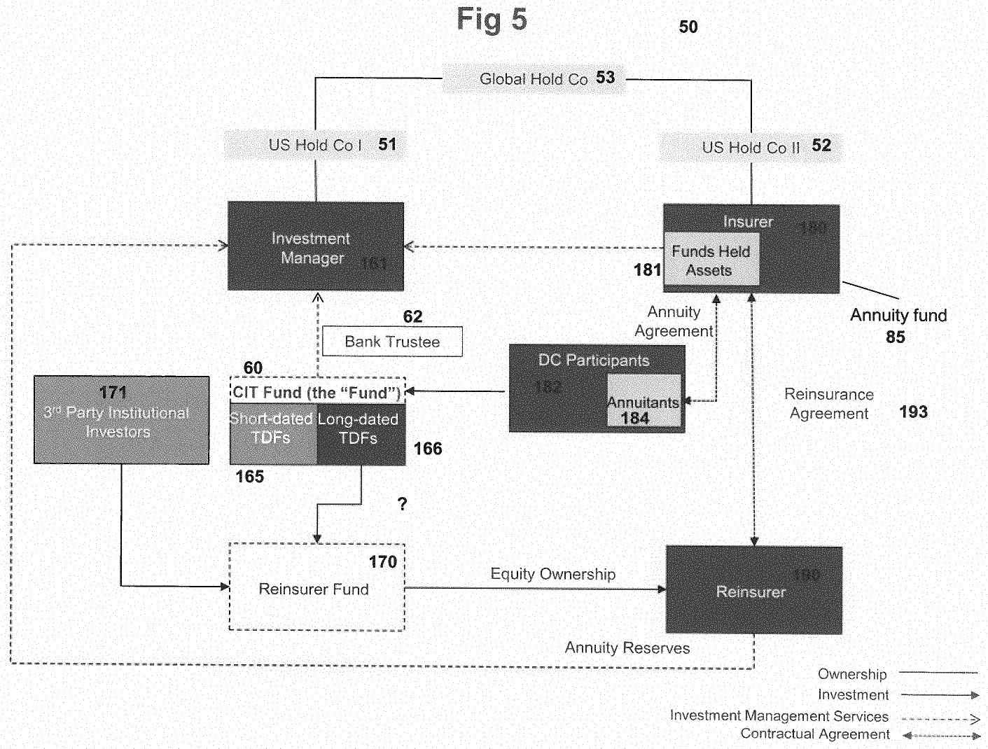

FIG. 5 is yet another example of a preferred embodiment of the present invention. The retirement reinsurance product 50 may include a global holding company 53. The global holding company may own an affiliated first holding company 51 and a second holding company 52. The holding companies 51 and 52 may be affiliated. The first holding company 51 includes a Collective Investment Fund (CIF) 60. The Collective Investment Fund 60 may be a group of pooled accounts that are held by a bank, financial institution or trust company. The financial institution may group assets from individuals or organizations to develop the single CIF 60 which comprises of a diversified portfolio. The CIF 60 is generally available to individuals only via employer sponsored retirement plans, pension plan and insurance companies, and are managed by a trustee 62. The CIF 60 may be created from a combination of short-dated target-date fund 165 and long-dated target date funds 166. The Collective Investment Fund 60 may also be created using the investment vehicle described in FIGS. 1-4 above. The CIF 60 may include a group of assets of individual securities or funds that form a single larger, diversified portfolio. The CIF 60 of the present invention includes the investment opportunity in a reinsurer fund 170 as part of the CIF 60. The reinsurer fund 170 may include separate reinsurer fund investors 200. The CIF 60 therefore includes short-term TDFs 165, long term 166 and reinsurer fund 170 correlates with the long term TDF 166. The CIF 60 may function as a mutual fund. Third party investors 171 may invest in the reinsurer fund 170. Therefore, the reinsurer fund 170 may include a periodic price quote that reflects the income available to an investor based upon the current account value, a desired income start date for an annuity 184 and the standard actuary annuity pricing. An investor has the opportunity to convert all or a portion of the account balance in the short term TDFs 165 or long term TDFs 166 to an annuity by selecting the available quote.

The TDF Funds 165 and 166 generally comprise of mutual funds. However, a sponsored retirement plan may have a wide variety of participants with some being close to retirement age while others may not retire for another 30 years. Under the present invention, there may be insurance equity funds or annuities 184 that are available to be purchased by anyone who desires to purchase the annuity. Purchase of the reinsurance fund 170 is available only to the participants 164 in the CIF Fund 60. Thus, the reinsurance fund 170 is held to those participants 164 who purchased the short-dated TDFs 165 and long-dated TDFs 166.

The Collective Investment Fund 60 investment in a reinsurer fund 170 which may also be supported by institutional investors 171. The reinsurer fund 170 may also be supported by annuity participants 182 that invest in the CIF 60.

The second holding company 52 may own an insurer 180. The insurer 180 has funds held assets 181. The insurer 180 has a contractual agreement or annuity agreement with participants 182 in a defined contribution plan. The participants 182 contract for annuities 184 that are held by an insurer 180.

The insurer 180 may enter a reinsurance agreement with a reinsurer 190. The reinsurer 190 may be owned by the reinsurer fund 170. The reinsurer 180 also may have annuity reserve with the investment manager 161.

The investment guidelines for the longer-dated TDFs (such as 2035 and 2040 TDFs) may allow a portion of the TDFs 166 to be invested in the Reinsurer Fund 170. The disclosure regarding the TDFs that is provided to plan participants will clearly explain the required investment and the risks and potential benefits of that investment. Just like any other investment made by these TDFs 166, the participants 182 would bear the risk of a loss on investment in the Reinsurer Fund 170. A loss in the Reinsurer Fund 170 would occur if the Insurer 180 substantially mis-priced the annuities issued to participants moving to an annuity 184 from the shorter-dated TDFs 165.

The Insurer 180 is not a party in interest due to its relationship with the Investment Manager 161 because the Insurer 180 is the corporate sibling of the Investment Manager 161. A relationship not included in the statutory definition of “party in interest” found in section 3(14) of ERISA. As a result, there should be no violation of section 406(a) of ERISA.

The Insurer 180 is not a fiduciary to any of the plans of the current invention such as the participant plan 182 or the CIF Fund 60 or the Reinsurer Fund 170. This is because the Insurer 180 does not have discretionary authority over the assets of the CIF 60, the Short-Dated TDFs 165 or the Long-Dated TDFs 166. If the Insurer 180 were given authority to decide which assets of a TDF 165, 166 should be transferred in-kind, such authority would be made as a business decision for the Insurer 180—a decision as to which assets are acceptable assets to be held by the Insurer 180. Even if the Insurer 180 were considered to be a fiduciary, the Insurer's 180 policies regarding the in-kind transfer will be pre-established and will require that a pro-rata portion of the assets of the applicable TDF 165, 166 be transferred in-kind to the Insurer 180. The Insurer 180 will have no discretion to decide whether assets will be transferred in kind or which assets will be transferred in kind. In addition, as previously explained, each TDF 165, 166 will have an independent Fund Accountant 62 as well as clearly documented pricing policy to ensure pricing transparency. For in-kind asset transfers, the value of assets transferred in-kind from a TDF 165, 166 will be determined by the independent Fund Accountant 62 which will adhere to the documented pricing policy. Neither the Insurer 180 nor the Investment Manager 161 will have discretion to determine the asset values for purposes of the in-kind asset transfers.

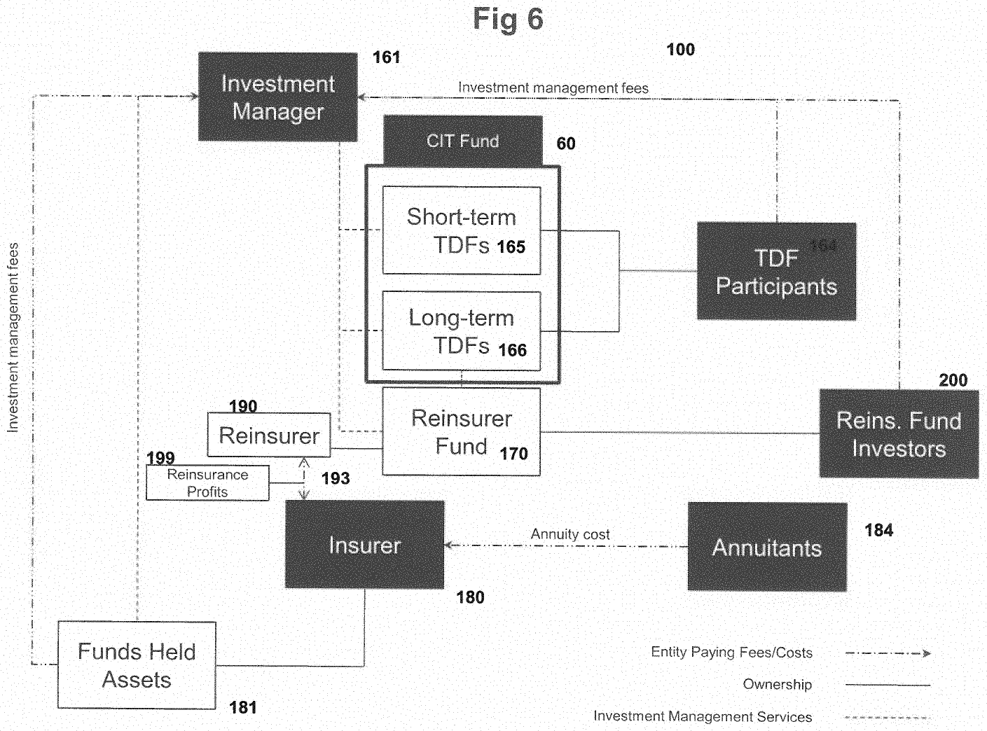

Turning now to FIG. 6, the diagram depicts the flow of fees in the Retirement Reinsurance Plan 100.

The Investment Manager 161 specializes in fixed income, index funds, and customized retirement solutions (for both Defined Benefit and Defined Contribution plans). A percentage of the fixed income assets are managed on behalf of insurance companies and other entities utilizing the same basic strategy and guidelines that would be applied to managing the Funds Held Assets 195 of the proposed structure.

The Investment Manager 161 also serves as the sub-advisor to a series of Target Date mutual funds such as short-term TDFs 165, long-term TDFs 166 and a Reinsurer Fund 170. The Investment Manager 161 provides asset allocation advisory services for the funds in the Target Date Funds 165, 166.

The Product 100 is not designed to increase the fees payable to the parties. The fees that are paid in the Product 100 are no different than the fees that otherwise would be paid in the general marketplace to the parties (the “Parties”) involved in the Product 100. There is a high likelihood that the fees charged to participants may be lower than the fees incurred if the participants purchase annuities separately from the TDFs. Below are the applicable fees for the Product 100:
The manager of the TDFs 165, 166 receives an investment management fee. This is the case with all investment managers of a TDFs 165, 166.
The bank trustee 162 of the bank-maintained collective investment TDFs 165, 166 will receive a fee, which also is the case with all TDFs 165, 166 that are bank-maintained collective investment funds. The bank may be an unrelated third party bank 71 that customarily acts as a trustee of bank-maintained collective investment funds. The bank could be affiliated bank or a bank with some or relationship to the bank trustee 162.
The manager of the Funds Held Assets 181 and Reinsurer assets 170 may receive a management fee. The Insurer 180, through use of an investment manager, invests the Funds Held Assets 181 in an effort to generate more investment income from the premiums than it ultimately must pay out under its insurance products. In the open market, the cost of annuities to a purchaser (i.e., the retired plan participant) reflects the costs to the insurance company issuing the annuity of paying investment management fees for the management of its premiums.
The Insurer 180 will be reimbursed by the Reinsurer 190 for administering the annuity contracts 184, which will be a fixed annual per policy amount. This cost is also indirectly passed through to the holder of an annuity 184 in the general marketplace.

The potential benefit of the Product 100 to the parties is not necessarily the fees described above. The fees above are consistent across the market landscape for both TDFs 165, 166 and annuities 184 for participants who invest in a TDFs 165, 166 and/or choose to purchase an annuity 184. Moreover, under the Product 100, the parties are giving up the potential benefit of longevity risk profits. The benefit of this Product to the parties is the ability to market a unique TDF product, which would lead to more assets under management for the Investment Manager, and the issuance of more annuity contracts 184. The parties do not have control over, nor do they provide investment advice with respect to, a participant's decision to purchase an annuity and, therefore, do not act as a fiduciary in connection with this decision. As a result, there is no assurance that the Insurer 180, in fact, will issue more annuity contracts. In addition, the fiduciary of the plan offering the TDFs 165, 166 decides whether to offer and continue offering the TDFs 165, 166.

The Investment Manager 161 is also able to provide additional benefits to short-dated TDF 165 or to older participants in the proposed structure. The fixed income allocations of CIF 60 will be designed to mimic the portfolio of assets that would be held by the Insurer 180 to support an annuity for that participant. The Reinsurer Fund operates to the benefit of the participants. This is an advantage both to participants who annuitize 184 as well as those who do not. The structure enables participants who purchase an annuity to transfer their plan assets in-kind to cover a portion or all of the upfront premium. This effectively saves participants 164 the transaction costs from selling their portfolio (i.e., to liquidate plan assets to provide cash), and paying another Insurer 180 to repurchase a similar or identical portfolio in the market. Given the increasing costs to transact in many markets central to annuity-like assets, this can represent an important savings to participants. For participants in the short-dated TDFs 165 who do not annuitize, particularly retirees who remain in the plan, the portfolio construction offers the benefits of transparency, liquidity and potential income like an annuity albeit without a guarantee. These benefits will support participants 164 and/or their advisors if they choose instead to utilize an advised or managed payout approach to retirement income.

The benefits of the proposed structure highlight the three sources of economic loss to participants who do not have access to the structure. First, annuities would otherwise be purchased, subject to commission charges, possibly in bulk through competitive bidding organized by the plan sponsor at a higher cost, or on the open market at an even higher cost. Second, regardless of alternate annuity purchase options, the reliance on a third-party insurer requires the liquidation of participants' plan assets to support the annuity purchase, resulting in significant and likely unnecessary transaction costs. Third, without the structure there are currently no other ways for participants to directly participate in returns to longevity risk, which reduces available return sources and diversification benefits to younger participants.

All retirement savers are exposed to losses. Participants exchange this risk of loss for the possibility of higher returns over the long-term as a way to grow their account balance and support retirement income needs. (Even participants who do not take the risk of investment loss—by holding only cash—are exposed to the loss of purchasing power due to inflation.) Investors in the Reinsurer Fund (e.g., through the long-dated TDFs) will be exposed to longevity risk underlying the annuities issued to participants. Over the long-term, returns to longevity risk are expected to be positive and a potential meaningful contributor to supporting participants' retirement income needs. However, as mentioned previously, because participants who hold exposure to the Reinsurance Fund 170 (i.e., the long-dated TDFs 166) are exposed to risks that have low or no correlation to their other investments, over time they are expected to be significantly better off by holding that investment, due to anticipated investment risk reduction and potential for enhanced returns.

The participants in longer-dated TDFs 166 or direct investors in the Reinsurance Fund 170 are exposed to losses arising from annuitant mortality and potential credit losses in the funds held assets. Both the Insurer 180 and the Investment Manager 161 would follow industry best practices to mitigate these risks sufficiently.

Losses due to annuitant mortality arise if the longevity of the pool of annuitants is, on average, greater than the estimates provided by the most appropriate mortality table plus the risk premium typically charged by insurers providing annuities. This risk is mitigated by the size of the allocation to the Reinsurer Fund 170 within the longer-dated TDFs 166, which is anticipated to be relatively small compared to other higher risk exposures such as equity. (Equity allocations in longer-dated TDFs can be has high as 90-95%) The risk is further mitigated by the fact that mortality tables, insurance risk premiums and allocations to the Reinsurer Fund 170 can be adjusted appropriately and more frequently than the typically very slow moving changes in mortality trends. This risk would be adjusted through the pricing of future annuities—a method typically employed by insurers when mortality, and related assumptions have shown to be materially inaccurate. Finally, in adverse scenarios, the Reinsurance Fund 170 will retain the option to transfer excess risk pursuant to other reinsurance agreements.

The Funds Held Assets 181 protect the investment return that would be passed back to investors in the Reinsurance Fund 170 (including to those investing through longer-dated TDFs 166). Any credit losses are offset by the funds held assets 181. This risk is mitigated by prudent investment strategy, including provisions for credit losses that are reflected in annuity prices, as is customary practice. Further, the investment strategy would be subject to approval and regular review by the appropriate insurance regulatory entities, which would ensure the prudence of said strategy and the overall adequacy and quality of the portfolio supporting the annuities. As stated above, the Investment Manager 161 should have significant experience managing assets supporting insurance products that are issued by affiliates and third parties.

Longevity risk, or the risk of living longer than expected (and potentially outliving one's assets) is a problematic idiosyncratic risk for the individual. As more people approach retirement without defined benefit plan structures in place, retirees will likely turn to traditional insurance annuities to hedge this exposure. Insurance companies generate profits on annuities by pooling individual longevity risk (largely diversifying away the idiosyncratic risk), and investing the premiums to generate returns to meet the projected liability cashflows plus a profit. Insurance companies often originate annuities via an expensive distribution channel with sales commissions that ultimately reduce the annuity cashflow stream. There are also significant roundtrip costs to selling out assets in the participant plan account and then repurchasing many of these same assets to support the annuity—in a well-run TDF, we would anticipate overlap of as much as 80% between a pre-retiree portfolio in the short-dated TDF and an insurer annuity portfolio. Finally, insurers have equity stakeholders with high return on capital expectations. For annuitants, the goal of the present invention is to minimize the costs and inefficiencies associated with the annuity market to improve cashflow payouts in a low interest rate environment.

While longevity risk is a dangerous idiosyncratic risk for the individual, it is an attractive risk for investors when pooled. Longevity risk offers a return stream that is uncorrelated to traditional asset exposures, making it a powerful diversifier for investors. The reinsurance structure provides access to longevity risk returns for younger plan participants, while reducing costs for the annuitants.

The Reinsurer Fund 170 would be a standalone fund outside of the CIT Fund 60, initially owned by an affiliate of the Investment Manager 161. As annuities are issued, the long-dated TDFs 166 would invest a pro rata portion of the balance to fund the additional equity investment required by the relevant insurance regulators. Long-dated TDFs 166 within the CIT Fund 60 could invest in the Reinsurer Fund 170, as could third party institutional investors 171. The sole purpose of the Reinsurer Fund 170 would be to increase equity capital in the Reinsurer 190. The Reinsurer 190 may be a Vermont-domiciled special purpose reinsurer. The Reinsurer 190 may invest the capital received from the Reinsurer Fund in Treasury Bills and other investments approved by the relevant insurance regulators, and maintain adequate regulatory capital and stipulated surplus to reinsure the Insurer 180 for annuities offered within the structure. Both asset and longevity performance (risk and return) would be transferred to the Reinsurer 190 through the reinsurance agreement, and ultimately, to the investors in the Reinsurance Fund. Under the reinsurance agreement, the Reinsurer 190 would bear the risk for a pro rata share (known as a “Quota Share”) of the profits or losses of the annuities. The Reinsurer 190 may reinsure 80-100% of the annuities (i.e., a 80-100% Quota Share) issued by the Insurer 180 to participants 182. Reinsurance Fund 170 performance derives from the annuities profits or losses (i.e., asset performance net of annuitant liability payments), which would incorporate actual longevity experience versus expected longevity at the point of initial annuity pricing.

As additional annuities are provided to the Reinsurer Fund 170, the Reinsurance Fund 170 could accept additional investment to provide capital to support the Reinsurer 190. If the Reinsurer 190 defaults on its obligations under the Reinsurance Agreement 193 (payments due the Insurer 180 exceed Reinsurer 190 capital), the Insurer would be liable for maintaining payments to the Annuitants 184. In other words, the Insurer 180 remains primarily responsible to annuity holders in all cases. The use of reinsurance is required to provide an additional, separate pool of capital—the investment made by the Reinsurer Fund 170—to support the annuities, while allowing the long-dated TDFs to receive exposure to longevity risk, a risk not correlated to bond and equity markets.

Performance of the Reinsurer Fund 170 is based on performance of the Reinsurer 190 under the reinsurance agreement 193. The Reinsurer 190 would earn the asset returns earned by the Funds Held Asset 181 portfolio net of actual annuity payments. The actual annuity payments incorporate the longevity risk. If mortality rates are higher than originally expected (when the annuity contracts were written), the annuity liabilities will fall relative to the asset portfolio, resulting in longevity gains. Inversely, if mortality rates are lower than originally expected, the annuity liabilities will increase relative to the assets available to pay them, resulting in longevity losses. Should losses from asset performance and/or longevity exceed the available capital within the Reinsurer 190, the Insurer 180 would still be principally liable for the annuity payments to the annuitants.

Participants 164 in the collective investment trust pay a annual investment management fee for the TDFs 165, 166, which is a standard arrangement for all TDFs. It is anticipated that the TDFs will allocate their assets to underlying funds managed by the Investment Manager 161 or third parties 171. The investment management fee for the TDF 165 and 166 includes the fees for all funds underlying the TDFs' allocations. It is expected that the TDF fee will represent the weighted average fee of the underlying funds plus a small additional amount (if any) for the ongoing management by the Investment Manager 161 of the TDF allocations 165, 166. Therefore, any participants 164 in a TDF that allocates to the Reinsurer Fund 170 would pay only one investment management fee for the TDF. If the Investment Manager 161 is the sole manager of the TDFs 165, 166 that allocate to the Reinsurer Fund 170, all underlying fund fees will be fixed.

Participants 164 who purchase an annuity pay the full cost of the annuity 184 with a single upfront premium. The Insurer 180 will pay the Investment Manager 161 an investment management fee for the Funds Held Assets 181 supporting the annuities purchased by participants. This fee will be funded by the single upfront premium made by the participant and is embedded in the premium cost. This is also a common arrangement.

Plan-level fees, typically fees that cover the costs of administering the plan, are not charged by any of the entities in the proposed structure. Also, TDF fees indirectly paid by participants 164 through the TDF for investment management would cover all fees due to the independent trustee, independent fund accountant and custodian, such that the participant pays one price. Finally, the Reinsurer 190 would pay the Insurer 180 an arm's length fee for administering the annuities. The offering of these products would not result in duplicative fees or expenses to participants.

Funds Held Assets 181 will be derived from the premiums paid by the participants 164 who choose to purchase an annuity 184 with a portion (up to and including 100%) of their plan balance. It is expected that the annuities 184 will be held within the plan by those participants.

The arrangement does not pose any additional fees flowing to the Investment Manager 161 than otherwise would exist within the current marketplace for participants that employ a TDF or by individuals who purchase an annuity. The key difference with this structure is that the participant 164 is able to save considerable cost over what is available in the current marketplace, as well as participate in an additional source of return presently unavailable in the marketplace (to our knowledge). In summary, there are several benefits to participants, and, while fees do flow primarily to the Investment Manager 161, the fees associated with the proposed structure are of the same nature as would be paid by investors and annuitants without access to the proposed structure. In fact, by maintaining the annuity assets 184 under the management of the Investment Manager 161, the Investment Manager 161 is able to charge a more competitive management fee than third-party asset managers because the Investment Manager 161 has an overall larger pool of assets to manage (i.e., the TDFs 165, 166, Reinsurer Fund 170, and Funds Held Assets 181). Consolidating these fees and eliminating inefficiencies delivers significant anticipated cost savings to participants. For example:

1. In the current market participants pay an investment management fee for TDF investments; and,

2. In the current market, the premium charged to annuitants includes some amount to cover the investment management expense charged to (or borne by) the insurer.

In the proposed structure, investment management fees are reduced by consolidating the TDF investment management and Funds Held Asset 181 investment management with a single manager. This provides economies of scale and reduces transaction costs—benefits that are passed directly back to participants.

The inclusion of an annuity purchase option makes lifetime income projections available to all participants as frequently as daily, and based not on approved assumptions but rather on an actual price available to the participant. Further, the annuity quotes will reflect market influences on pricing such as interest rates and standard mortality tables, but—more importantly—will not include brokerage or other similar fees. Payments to brokers for the purchase of an annuity are a significant portion of the annuity cost (typically 1-3% of the purchase price). The proposed structure can provide the annuities directly, eliminating this cost and passing the savings on to participants.

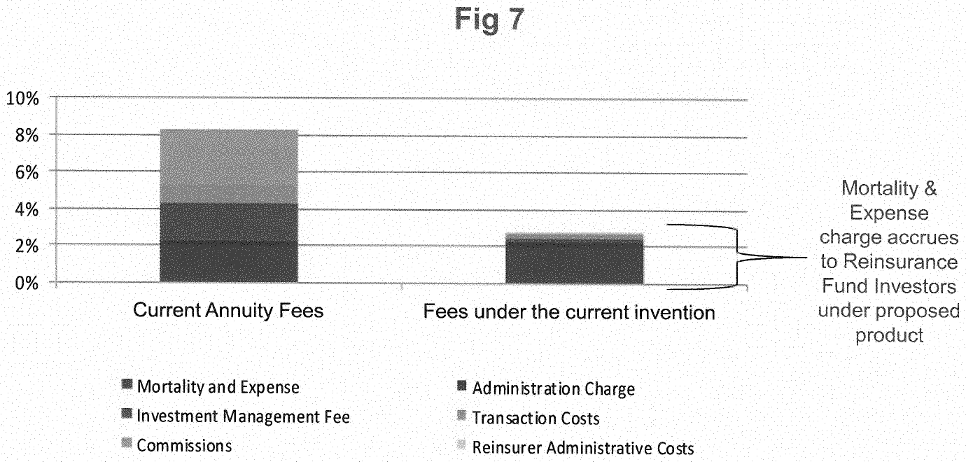

FIG. 7 shows an estimation of the comparison of estimated fees and estimated expenses, not actual fees, that may be saved by utilizing the current invention based upon predictions and assumptions. The graph of the estimated fees shows what is estimated, not actual cumulative additional wealth. The benefits to long-dated TDF (younger) 166 participants include access to a return stream (i.e., risk premium) uncorrelated with their other retirement savings assets and currently unavailable to them in any other format. Participants who invest in the longer-dated TDFs may hold an allocation to the Reinsurer Fund, which provides exposure. Adding investments with higher expected returns, and/or lower volatility and/or reduced correlation to other assets in a TDF is an essential aspect of providing better retirement outcomes. Investments with the aforementioned estimated characteristics can help grow participant retirement account balances even when other investments are performing poorly. Providing an uncorrelated asset within an investment lineup results in better risk-adjusted return, due to lowering the risk of the overall program via enhanced diversification benefits.

To provide a more concrete example of the potential benefits of the structure, a hypothetical example of an investor's experience can be created using historical investment returns and current annuity prices. The results below use a typical TDF glide path and historical returns for each underlying investment. Hypothetical returns for the Reinsurance Fund 170 are the same as those presented previously:
The example uses a 40-year career and savings period, assuming a participant begins saving at age 25 and retires at age 65. The starting salary is assumed to be $41,600 per year, increasing 3% annually, with contributions from the employee that increase gradually through time plus an employer match.
In one example, 5% of the total Equity holdings are reallocated by the Investment Manager from the TDF to the Reinsurance Fund. For example, if the TDF allocation is 85% Equity, the example including the Reinsurance Fund holds 4.25% in the Reinsurance Fund (i.e., 85% * 5%) and 80.75% equity (i.e., 85% * 95%). The glide paths are otherwise identical. The hypothetical benefits in this example are relatively insensitive to the exact glide path chosen. Any differences in wealth accumulation are driven primarily by the amount allocated to the Reinsurance Fund 170 instead of Equities.

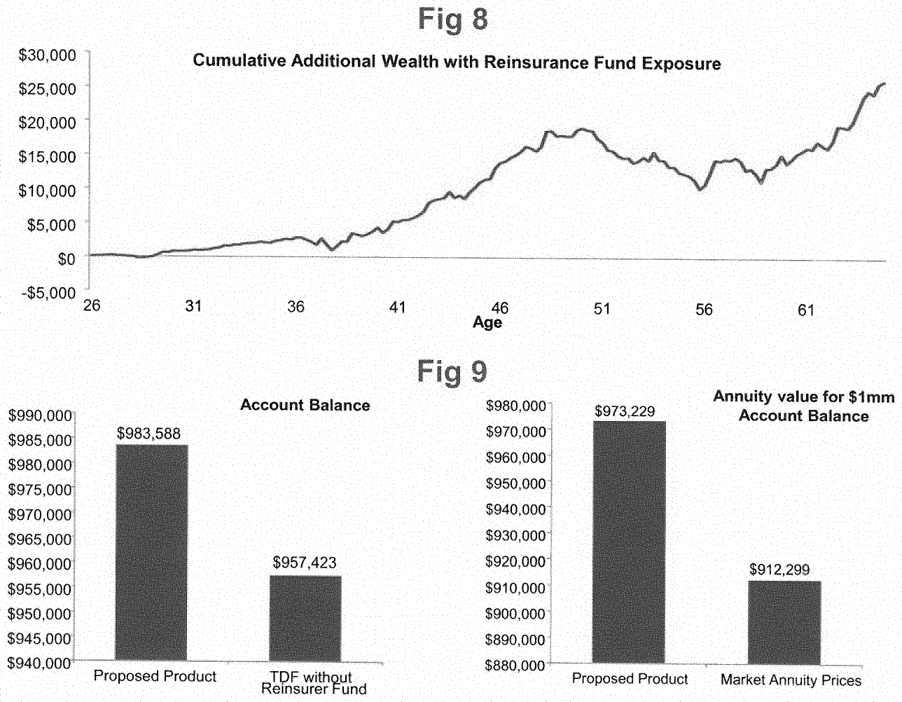

FIG. 8 shows the estimated additional wealth accumulated during the savings period in a TDF that allocates to the Reinsurance Fund 170 based on hypothetical predictions and assumptions. The graph is an estimation (not actual) of the predicted additional return that depicts the expected positive difference of the return on the Reinsurance Fund over the return to Equity. Even for a very conservative allocation to the Reinsurance Fund, there is an estimated material increase in the final account balance (approximately 3% in this example). The benefits available to participants under the proposed structure become even more significant when the participant purchases the annuity. The reduced transaction costs and reduced fees to the participant in the proposed structure result in as much as an estimated 7% improvement in income replacement.

FIG. 9 illustrates an estimated aggregate wealth accumulation to a participant in this Product at retirement age, compared to the value that would have been received without the allocation to the Reinsurance Fund 170. These charts are based on hypothetical estimations and assumptions rather than real figures. FIG. 9 also shows a participant's annuity under the Product, versus a participant's annuity purchase power cost in the open market. The higher costs of purchasing an annuity in the open market. These charts are based on estimations and not real figures.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations and permutations that nevertheless fall within the scope and spirit of the appended claims.

What is claimed is:

1. A system for managing a financial investment product in a defined contribution plan in which a participant makes a contribution to the defined contribution plan on a regular periodic basis comprising:
a collective investment fund managed by an investment manager;
A target date fund series of investment vehicles within the collective investment fund having a combination of short-dated target funds and long dated target funds wherein the total amount and type of funds held for participants is predetermined by the investment manager and meant to be appropriate for an investor at any given time based on a planned or assumed retirement date for the investor;
a reinsurer fund owned by a reinsurer wherein a portion of the target date funds from the managed fund are invested in the reinsurance fund;
a series of deferred annuities and single premium annuities which may be purchased by the investor which are maintained in the reinsurance fund, wherein the deferred annuities and the single premium annuities including the income start dates and the actuary-determined pricing factors;
a periodic price quote of the reinsurer fund which reflects the income available to the investor based on the account value, the deferred annuities and single premium annuities start dates and the actuary-determined pricing factors to allow an investor to convert an account balance in the target date funds to a reinsurance fund value;
an insurance platform held by a second holding company;
a funds held assets that constitutes part of the insurance platform wherein the funds held assets are managed by the investment manager;
a plurality of annuities owned by a plurality of participants in the defined contribution plan are held by an annuity agreement with the plurality of participants in the funds held assets whereby the plurality of participants in a defined contribution plan are investors in the collective investment fund; and
the reinsurer provides an annuity reserve managed by the collective investment fund manager.

2. The system for managing a financial investment product in a defined contribution

1. claim 1 wherein the reinsurer has a contractual relationship with the insurance platform in the form of a reinsurance agreement.

3. The system for managing a financial investment product in a defined contribution plan of claim 1 wherein the long-dated target-date fund include, for example, 2045 and 2050 type funds.

4. The system for managing a financial investment product in a defined contribution plan of claim 1 wherein the collective investment fund investment vehicle includes securities, funds and derivatives.

5. The system for managing a financial investment product in a defined contribution plan of claim 1 further comprising an insurance vehicle included in the insurance platform wherein the participants enter into an annuity contract with the insurance vehicle.

6. The system for managing a financial investment product in a defined contribution plan of claim 5 wherein the participants in the target date fund invests in the reinsurer fund.

7. The system for managing a financial investment product in a defined contribution plan of claim 6 wherein a dividend paid from the reinsurance fund is returned to the participants in the reinsurer fund.

8. The system for managing a financial investment product in a defined contribution plan of claim 7 wherein the participants have the option of purchasing an additional annuity with a portion of their retirement plan funds.

9. The system for managing a financial investment product in a defined contribution plan of claim 8, wherein the periodic annuity quote occurs daily for each trading session.

10. A system for managing a financial investment product in a defined contribution plan in which a participant makes a contribution to the defined contribution plan on a regular periodic basis comprising:
an investment vehicle containing assets including securities, funds or derivatives;
the investment vehicle provides units to a plurality of participants;
the investment vehicle provides a daily price quote based on the performance of the investment vehicle;
an insurance vehicle in which the investment vehicle is a one-hundred percent owner of the insurance vehicle, wherein the insurance vehicle provides annuity contracts with the participants;
a funds held assets associated with the insurance vehicle derived from premiums paid by a participant;
a longevity return generated by the annuity contracts flow into the funds held assets held within the insurance vehicle
a periodic annuity quote derived from the investment vehicle; and
a reinsurance platform associated with the insurance vehicle.

11. The system for managing a financial investment product in a defined contribution plan of claim 10, wherein the participant elects to annuitize an investment by using the value of fund units accumulated by the participant.

12. The system for managing a financial investment product in a defined contribution plan of claim 10, wherein the dividends paid to the participants from the insurance vehicle are invested in the investment vehicle.

13. The system for managing a financial investment product in a defined contribution plan of claim 10, wherein any money generated from the annuitized participants is transferred to the surplus account.

14. The system for managing a financial investment product in a defined contribution plan of claim 13, wherein the periodic annuity quote is published daily for each trading session.

15. A system for managing a financial investment product in a defined contribution plan in which a participant makes a contribution to the defined contribution plan on a regular periodic basis comprising:
an investment vehicle containing assets that include short-term target date funds and long-term target date funds owned by TDF participants;
a reinsurer fund containing assets owned by reinsurance fund participants and a reinsurer;
the reinsurer fund comprising a portion of the investment vehicle;
the reinsurance fund providing a periodic price quote based on the performance of the investment vehicle;
an insurance platform that contains a funds held assets including one or more annuities held by a TDF participants, whereby the funds held assets correlate to the investment vehicle.

16. The system for managing a financial investment product in a defined contribution plan of claim 15 further comprising investment management fees paid by the TDF participants for investments in the target date funds are collected by an investment manager in a manner that does not impose additional costs or expenses beyond what would be customary and competitive in the marketplace.

17. The system for managing a financial investment product in a defined contribution plan of claim 16 further comprising reinsurance fund investor fees paid by the reinsurance fund investors for purchase of a unit in the reinsurance fund which are collected by the investment manager.

18. The system for managing a financial investment product in a defined contribution plan of claim 17, further comprising a funds held asset fee paid by an insurer for annuities purchased as part of the insurance platform to the investment manager.

19. The system for managing a financial investment product in a defined contribution plan of claim 18, further comprising a reinsurance profit generated by the insurance platform that is paid to the reinsurer.

20. The system for managing a financial product in a defined contribution plan of claim 15, wherein the periodic price quote for the investment vehicle is published daily for each trading day.
